(19) United States
(12) Patent Application Publication
(10) Pub. No.: US 2015/0025935 A1
(43) Pub. Date: Jan. 22, 2015

(54) CONTENT TRIAL USAGE VIA DIGITAL CONTENT DELIVERY PLATFORM

(71) Applicant: Verizon Patent and Licensing Inc., Basking Ridge, NJ (US)

(72) Inventors: Jianxiu Hao, Lexington, MA (US); Ishan Awasthi, Wilmington, MA (US); Gaurav D. Mehta, Brookline, MA (US)

(73) Assignee: Verizon Patent and Licensing Inc., Basking Ridge, NJ (US)

(21) Appl. No.: 13/946,025

(22) Filed: Jul. 19, 2013

(51) Int. Cl. G06Q 30/02

(52) U.S. Cl. CPC G06Q 30/0201
USPC 705/7.29

(57) ABSTRACT

A content distribution platform receives a respective trial time window for each of multiple items of digital content stored at the content distribution platform, and offers one of the items of the digital content to multiple customers during the respective trial time window. The content distribution platform tracks, during the respective trial time window, usage of the one of the plurality of items of digital content by one or more of the multiple customers. The content distribution platform generates, based on the tracked usage, a first usage report for the one of the multiple items of digital content at expiration of the respective trial time window

### BACKGROUND

Content delivery networks (CDNs) are interconnected systems of servers that can rapidly and cost effectively deliver a variety of digital content to numerous end points, such as web browsers, mobile devices, set-top boxes and gaming consoles, via the Internet. CDNs include large distributed systems of servers located in multiple data centers in the Internet. CDN nodes are typically deployed in multiple different locations, often across multiple different backbones. The number of nodes and servers of a CDN varies, depending on the CDN's architecture. CDNs serve a substantial portion of content on the Internet, including text, graphics, Uniform Resource Locators (URLs), scripts, media files, software, documents, applications, social networks, and streaming media.

For serving content via streaming media, CDNs may, for example, use Hypertext Transfer Protocol (HTTP) Live Streaming (HLS). HLS is a HTTP-based media streaming communications protocol that involves breaking the media stream into a sequence of file downloads. Each file may be downloaded as one portion of a transport stream. Each downloaded file may be played in sequence to present a continuous media stream. As a given stream is played, the client may choose from multiple different alternative streams containing the same content encoded at various data rates. At the beginning of a streaming session, the client downloads a playlist file that specifies the different or alternate streams that are available.

In HLS, a given multimedia presentation is specified by a Uniform Resource Identifier (URI) to the playlist file, which itself includes an ordered list of media URIs and informational tags. Each media URI refers to a media file that is a segment of a single continuous media stream. To play a stream, a client first obtains the playlist file and then obtains and plays each media file in the playlist in sequence.

### BRIEF DESCRIPTION OF THE DRAWINGS

FIG. 1 illustrates an overview of an exemplary implementation of a digital content delivery platform delivering digital trial content to customers, and tracking those customers' usage of the digital trial content;

FIG. 2 depicts an exemplary network environment in which the digital content delivery platform of FIG. 1 delivers digital trial content to customers and tracks those customers' usage of the digital trial content;

FIG. 3 depicts exemplary details of the network server components of the digital content delivery platform of FIG. 1 and their interaction with content providers and customer devices for delivering digital trial content and tracking usage of the digital trial content during usage trials;

FIG. 4 is a diagram that depicts exemplary components of a network device that may correspond to the customer devices, content providers and network server components of the digital content delivery platform;

FIG. 5 depicts an exemplary data structure that stores one or more trial records that each correspond to an item of digital trial content provided by a respective content provider for trial usage by customers;

FIG. 6 is a flow diagram of an exemplary process for receiving digital trial content at the digital content delivery platform and for conducting usage trials of the received trial content;

FIG. 7 depicts an exemplary user interface that the administrator of the content provider may use to upload digital trial content;

FIG. 8 is a flow diagram that depicts exemplary details of the trial content customer usage tracking block of FIG. 6;

FIG. 9 is a diagram of an exemplary user interface associated with the exemplary process of FIG. 8; and

FIG. 10 depicts an exemplary media player that may be implemented by a customer device to present trial content to a customer.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

A digital content distribution platform, as described herein, enables digital content providers to elect to place their digital trial content within usage trials conducted by the digital content distribution platform, where customers are able to use the trial content on a trial basis. Customers may be notified, via one or more different types of electronic notification, of the usage trials to be conducted by the digital content distribution platform. During the conduct of the content usage trials, customers' interactions with the content and/or with the digital trial content distribution platform may be tracked. Such interactions may include, for example, tracking a title of content being browsed by a customer, tracking a title of content being previewed by a customer, or tracking how a title is watched by a customer (e.g., fast forward positions, repeated positions). The digital content distribution platform may conduct specific usage trials of digital content based on trial time windows specified by the content providers. At the expiration of a trial time window for a given usage trial, the digital content distribution platform may generate a usage report that details the customers' usage of the trial content. The digital content distribution platform may provide the generated usage report to the content provider that originally supplied the digital trial content.

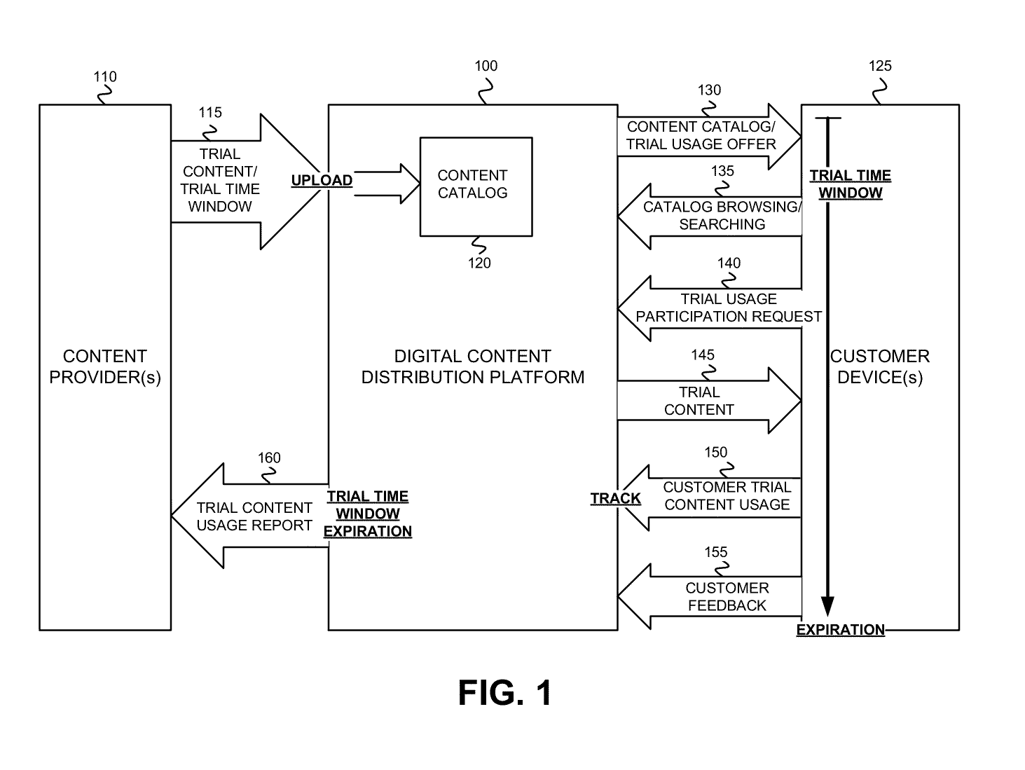

FIG. 1 illustrates an overview of an exemplary implementation of a digital content distribution platform (DCDP) 100 delivering digital trial content to customers, and tracking those customers' usage of the digital trial content during usage trials. As shown in FIG. 1, a content provider(s) 110 may upload selected digital trial content 115 to DCDP 100 that content provider(s) 110 elects DCDP 100 to permit customers to participate in usage trials of digital trial content 115. In addition to uploading the trial content 115, the content provider(s) 110 may upload trial content attributes that may include, among other attributes described further herein, a selected trial time window. The selected trial time window may define a length of a usage trial to be conducted by DCDP 100 for the uploaded digital trial content (e.g., a day, a week, 8 hours, etc.). The digital trial content may include one of various types of digital content, including, for example, digital video content or digital audio content. The digital trial content may include, for example, selected portions of digital video or digital audio content (e.g., selected portions of a movie or a series of movies). DCDP 100 may integrate trial content 115 into a content catalog 120 that stores multiple different items of digital content.

Data related to content catalog 120, that includes a trial usage offer 130 of trial content 115, may be provided to the customer(s) at customer device(s) 125. The customer(s), using customer device(s) 125, may browse and/or search 135 the content catalog. The offer of the trial usage of trial content 115 may include DCDP 100 offering the digital trial content 115 to a customer(s) at a respective customer device(s) 125 for the duration of the trial time window received from content provider(s) 110. The beginning of the offering 130 of the digital trial content initiates a timer associated with the trial time window. In response to the offering, the customer(s), via customer device(s) 125, may send a request 140 that requests participation in the trial usage of the digital trial content. Upon receipt of request 140, DCDP 100 may, prior to expiration of the trial time window, provide the requested digital trial content 145 to customer device(s) 125 of the requesting customer(s).

During the customer's catalog browsing/searching 135 and trial usage 150 of trial content 145, DCDP 100 may track the customer's usage. Tracking the customer's usage may include tracking the customer's browsing of the content catalog, including specifically browsing trial content 135; tracking the customer's browsing of a detailed description of trial content 135 from content catalog 120; tracking the customers' watching/listening to previews of the digital trial content; tracking a length of use of the digital trial content by a customer; tracking a type of customer device 125 (e.g., web, mobile, TV) used by a customer to engage in the trial usage; tracking a location of the customer's trial usage (e.g., city, geographic location by latitude/longitude); or tracking how the digital content was watched/listened to (e.g., fast forward positions, pause positions, repeated positions).

At the conclusion of usage 150 of the digital trial content, the customer(s) at customer device(s) 120 may provide customer feedback 155 to DCDP 100. The customer feedback 155 may relate to the digital trial content, or to promotions and/or advertisements presented to the customer during the trial usage 150.

Using a timer, DCDP 100 may determine that the trial time window for the digital trial content has expired. Upon expiration of the trial time window, DCDP 100 may generate a usage report 160 of the trial usage of the digital trial content by customer(s) using customer device(s) 125. The generated report of the trial usage may include:

1) a title of digital trial content being browsed and by how many customers;

2) a title of digital trial content being previewed and by how many customers;

3) a title of digital trial content being watched/listened to and by how many customers;

4) a title of digital trial content and how the trial content was watched/listened to by customers (e.g., pause positions, fast forward positions, stop positions, repeating positions).

5) what other titles of digital trial content that a customer watched who watched a given title of digital trial content;

6) customers' feedback for each title; and/or

7) customers' feedback for promotions/advertisements associated with given titles of digital trial content.

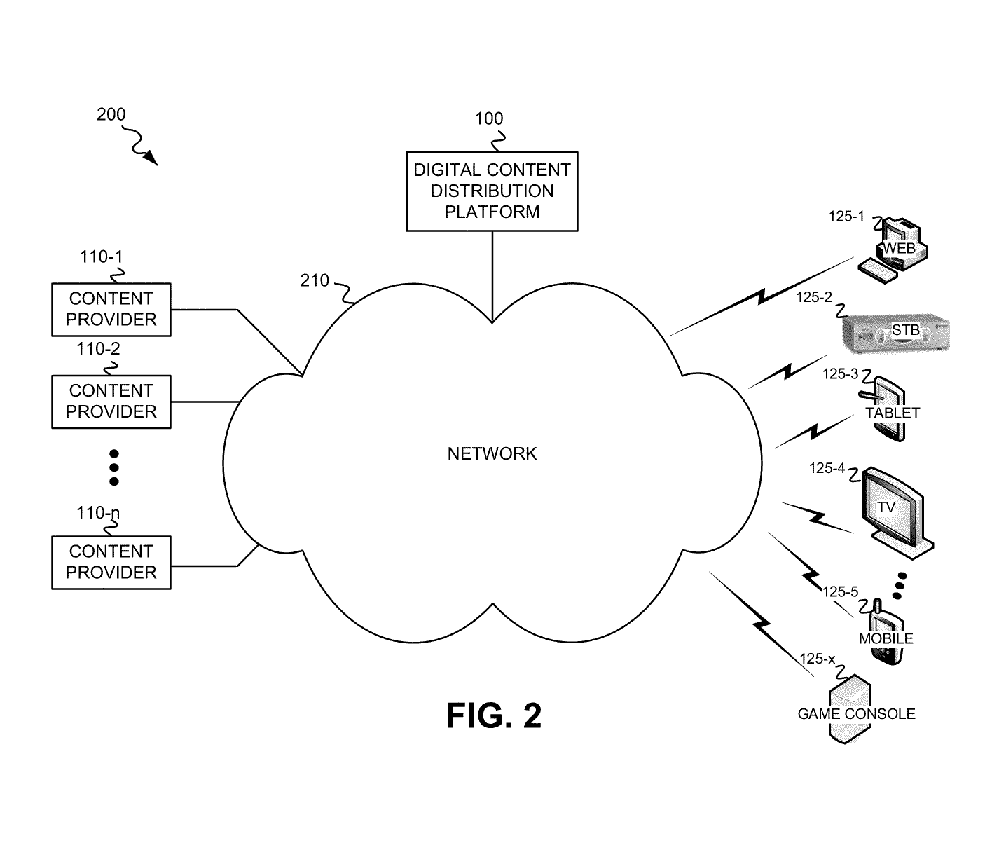

FIG. 2 depicts an exemplary network environment 200 in which DCDP 100 delivers digital trial content to customers, and tracks those customers' usage of the digital trial content. Network environment 200 may include a digital content distribution platform 100, content providers 110-1 through 110-n (where n is greater than or equal to 1), customer devices 120-1 through 120-x (where x is greater than or equal to 1), and network 210.

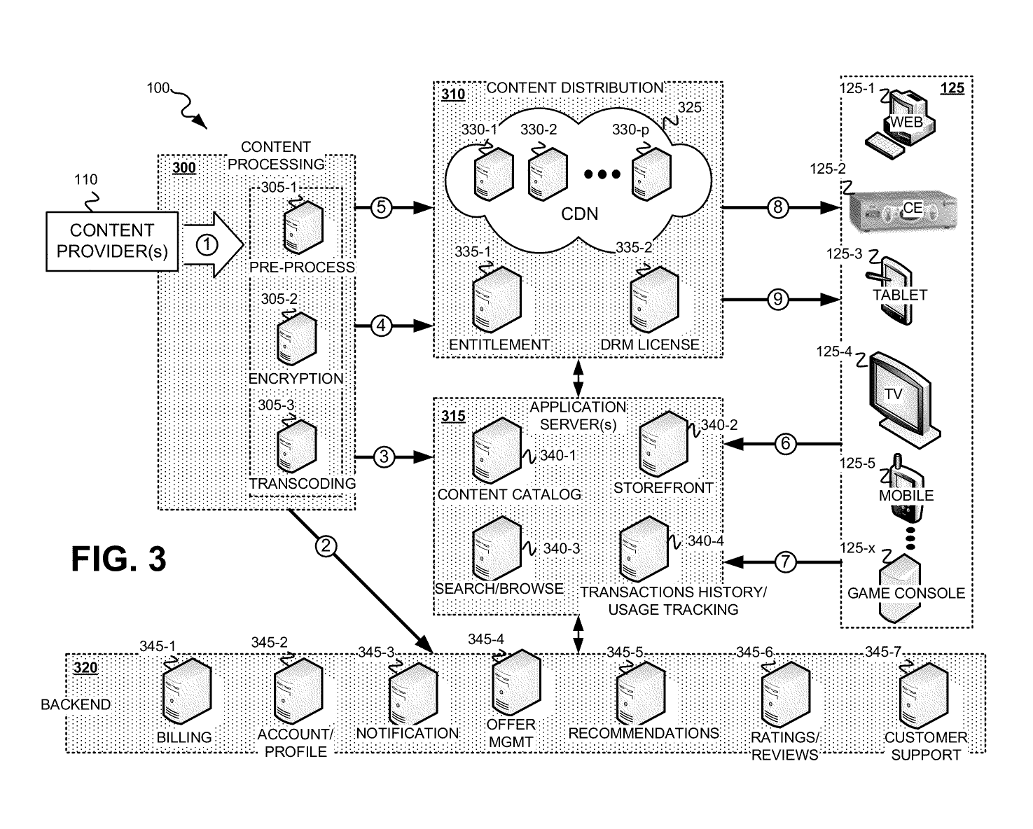

DCDP 100 may include one or more servers that perform various functions to assist in the streaming of, or downloading of, digital content to customer devices 125 via a content delivery network of network 210. “Digital content,” as referred to herein, includes a unit of digital content that may be provided by DCDP 100 to customer devices 125. The unit of digital content may include, for example, a segment of text, a defined set of graphics, a URL, a script, a program, an application or other unit of software, a media file (e.g., a movie, television content, music, etc.), a document, or an interconnected sequence of files (e.g., HLS streaming media files). “Digital trial content,” as referred to herein, includes digital content that has been selected by a content provider 110 for offering to customers on a limited, trial basis via DCDP 100. “Digital trial content” may include portions of an original item of digital content, or a series of original digital content, or “digital trial content” may include an entirety of the original item of digital content. The trial basis for the “digital trial content” may be offered to customers for free, for a fee, or based on the customers providing their feedback/comments on the digital trial content. Various exemplary servers of DCDP 100 are described further below with respect to FIG. 3.

Content providers 110-1 through 110-n may each include a network device(s) that stores digital content and/or digital trial content, and which may implement a user interface tool for uploading content to DCDP 100. Network 210 may include one or more networks including, for example, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., Public Switched Telephone Networks (PSTNs)), a local area network (LAN), a wide area network (WAN), a metropolitan area network (MAN), an intranet, the Internet, or a cable network (e.g., an optical cable network). Network 210 may include a content delivery network (not shown) having multiple nodes that allow the streaming of, or downloading of, digital content from DCDP 100 to customer devices 125. The CDN is described further below with respect to FIG. 3.

Each of customer devices 125-1 through 125-x may include any type of computational device that may communicate with DCDP 100 and/or other servers, to receive digital content from DCDP 100. Each of customer devices 125 may include, for example, a computer (e.g., desktop, laptop, palmtop or tablet computer), a Personal Digital Assistant (PDA), a cellular telephone (e.g., a “mobile” smart phone), a Set-Top Box (STB), a game console, or a TV (e.g., a “smart” TV).

The configuration of network components of network environment 200 shown in FIG. 2 is for illustrative purposes. Other configurations may be implemented. Therefore, network environment 200 may include additional, fewer and/or different components, that may be configured in a different arrangement, than that depicted in FIG. 2.

FIG. 3 depicts further exemplary details of network server components of DCDP 100 and their interaction with content provider(s) 110 and customer devices 125 for delivering digital trial content and tracking usage of the digital trial content during usage trials. As shown in FIG. 3, DCDP 100 (the components of which are depicted in a shaded fashion in FIG. 3) includes content processing servers 300, content distribution servers 310, application servers 315, and backend servers 320.

Content processing servers 300 may include a pre-processing server 305-1, an encryption server 305-2, and a transcoding server 305-3. Pre-processing server 305-1 may include a network device that receives digital content and/or digital trial content from content provider(s) 110 (shown with a “1” within a circle) and converts the content into a standardized format. Encryption server 305-2 may include a network device that applies digital rights management (DRM) rules to encrypt the digital content so that only authorized customers and devices can consume the content.

Transcoding server 305-3 may include a network device that converts the digital content into proper formats for different types of consumer devices. The output file for the digital content can be one large file for downloading, or a series of segment files for streaming. The segment files may have different resolutions so that different bit rate streams can be delivered via the network bandwidth for smooth streaming. In an exemplary implementation, transcoding server 305-3 may convert the digital content received from content provider(s) 110 into HLS files or Smooth Streaming files. As depicted with a “2” within a circle in FIG. 3, content processing servers 300 may send metadata associated with the digital content provided by content provider(s) 110 to backend servers 320 and to application servers 315. Additionally, content processing servers 300 may send the metadata associated with the digital content or digital trial content provided by content provider(s) 110 and a content catalog (shown with a “3” within a circle) to application servers 315. The content catalog may include a complete library of digital content provided by content provider(s) 110, with associated data that can be used for searching the content catalog. As further depicted with a “4” within a circle, content processing servers 300 may send encryption keys for digital content encrypted by encryption server(s) 305-2 to content distribution server(s). Content processing servers 300 may additionally send encrypted digital contents, encrypted using the encryption keys, to content distribution servers 310, as shown with a “5” within a circle in FIG. 3.

Content distribution servers 310 may include a content delivery network (CDN) 325, which further includes content delivery nodes 330-1 through 330-p, an entitlement server(s) 335-1 and a DRM license server 335-2. CDN 325 includes multiple content delivery nodes 330-1 through 330-p that deliver digital content to customer devices 125. The nodes of CDN 325 may be distributed geographically based on customer demand in different geographic regions. Entitlement server(s) 335-1 may include a network device that stores an entitlement database that contains the encrypted digital content received from content processing servers 300, as an encrypted content catalog, that is available for purchase, rental, subscription, and/or for trial usage (as described herein). Entitlement server 335-1 associates the encrypted content catalog to a customer's profile to enforce what content the customer can consume, and on which device the customer may consume the content. Entitlement can be verified before a DRM license key can be issued to a customer device 125. Entitlement may also be verified before application servers 315 issue a content download URI or URL to CDN 325 so that only entitled customers have access to encrypted content. The encrypted digital content may only be consumed by entitled customers on designated devices having DRM protections.

DRM license server(s) 335-2 may include a network device that interacts with content processing servers 300 to ensure that digital content is encrypted according to DRM rules. DRM license server(s) 335-2 issues, validates, and enforces the DRM licenses to customer devices 125. DRM license server(s) 335-2 distributes DRM license keys so that only those customers who are entitled to may consume the content on designated customer devices 125 with DRM protections.

Application servers 315 may include a content catalog server(s) 340-1, a storefront server(s) 340-2, a search/browse server(s) 340-3, and a transactions history/usage tracking server(s) 340-4. Content catalog server(s) 340-1 may include a network device(s) that stores a unified unencrypted catalog of content that customers may browse and/or search to buy, rent or subscribe content, or elect to participate in a trial of digital trial content. The catalog of content may, in addition to other content, include trial usage content provided by content provider(s) 110, as described further herein.

Storefront server(s) 340-2 may include a network device(s) that implements transaction management (e.g., a shopping cart), and the management of promotions and advertisements. Search/browse server(s) 340-3 may include a network device(s) that searches the unencrypted content stored in content catalog server(s) 340-1, and may locate relevant content based on, for example, one or more keywords. Search/browse server(s) 340-3 may also permit customers to browse the content stored in content catalog server(s) 340-1 via, for example, a hierarchical catalog structure (e.g., alphabetical by title, by date).

Transactions history/usage tracking server(s) 340-4 may include a network device(s) that tracks customers' usage of the content (including digital trial content) stored in content catalog server(s) 340-1, including customers' interactions with any of application servers 315, and the transactions in which the customers engage. Server(s) 340-4 may track and store transaction history information that details digital content viewed, rented and/or purchased for each customer.

Customers, at customer devices 125, may, via search/browse server(s) 340-3, search and/or browse content in the content catalog stored by content catalog server 340-1, as shown with a “6” within a circle in FIG. 3. Upon selection of desired digital content, the customer at a customer device 125, may log-in and purchase the selected digital content, as shown with a “7” within a circle in FIG. 3. Customers, at customer devices 125, may initially be notified of the presence of digital content currently being offered for trial usage via notification server(s) 345-3 of backend server(s) 320.

Backend servers 320 may include one or more servers for performing backend functions. Backend servers 320 may include a billing server(s) 345-1, an account/profile server(s) 345-2, a notification server(s) 345-3, an offer management server(s) 345-4, a recommendations server(s) 345-5, a ratings/reviews server(s) 345-6 and a customer support server(s) 345-7.

Billing server(s) 345-1 may include a network device(s) that processes rental and purchase transactions of content from DCDP 100 by customers at customer devices 125. Billing server(s) 345-1 may also process content catalog subscriptions that enable customers at customer devices 125 access to content stored at DCDP 100. The subscriptions may be billed, for example, automatically each month. Billing server(s) 345-1 may act in conjunction with entitlement server(s) 335-1 to determine which customers are entitled to access content at designated different ones of customer devices 125.

Account/profile server(s) 345-2 may include a network device(s) that maintains account information associated with customers at customer devices 125, including log-in credentials used for validating log-ins of customers. The account information may include, for example, contact names, email addresses, mailing addresses, billing information, authorized device information, entitlement rights of content, and customer profiles (e.g., customer preferences). Notification server(s) 345-3 may include a network device(s) that provides electronic notifications to customers regarding content stored in the content catalog. The electronic notifications may include, for example, email notifications, system notifications (e.g., pop-up displays upon customer log-in), Instant Messaging (IM) notifications, or social network notifications.

Offer management server(s) 345-4 may include a network device(s) that generates offers related to customer purchase or rental of digital content, and/or offers related to digital content trial usage. Server(s) 345-4 may additionally obtain or generate promotions and/or advertisements for provision in conjunction with the digital content trial usage. Recommendations server(s) 345-5 may include a network device(s) that recommends content to a searching or browsing customer based on, for example, the customer's profile (e.g., customer preferences), content usage history, or content transaction history.

Ratings/reviews server(s) 345-6 may include a network device(s) that receives, stores and tabulates customer ratings, feedback, and/or reviews associated with digital content stored in the content catalog, or associated with promotions or advertisements provided in addition conjunction with digital content (including digital trial content). Customer support server(s) 345-7 may include a network device(s) that provides a handles customer service-related feedback, customer questions, or credit related customer questions or requests.

The configuration of components of DCDP 100 shown in FIG. 3 is for illustrative purposes. Other configurations may be implemented. Therefore, DCDP 100 of FIG. 3 may include additional, fewer and/or different servers that may be configured in a different arrangement than that depicted in FIG. 3.

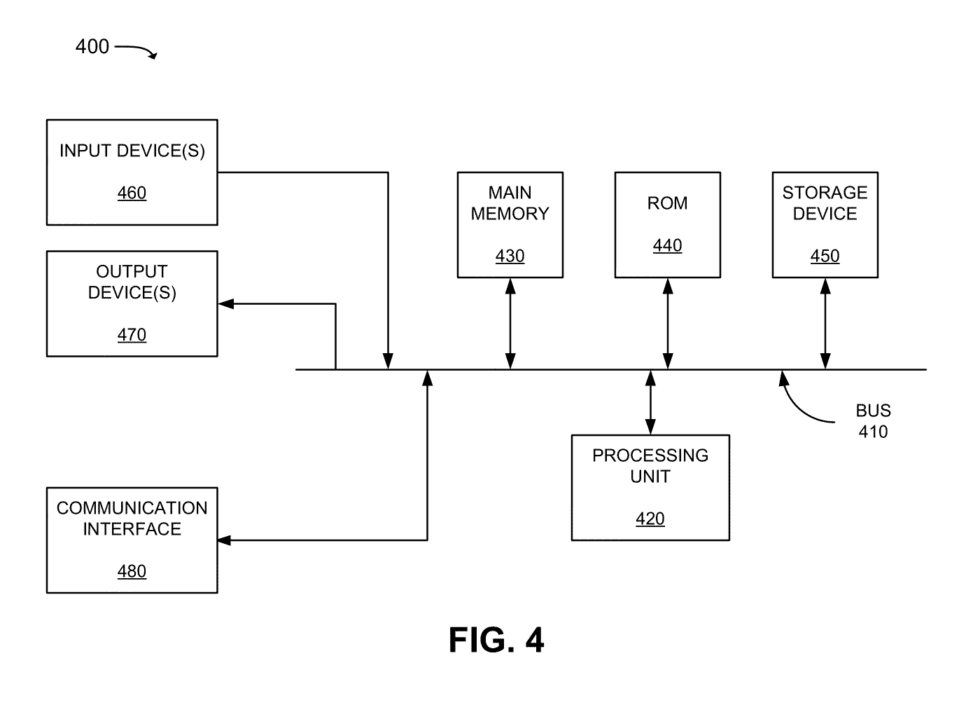

FIG. 4 is a diagram that depicts exemplary components of a network device 400. Network device 400 may correspond to any of the servers of DCDP 100 (e.g., encryption server 305-2, entitlement server 335-1, content catalog server 340-1). Network device 400 may further correspond to each of content providers 110, and each of customer devices 125.

Network device 400 may include a bus 410, a processing unit 420, a main memory 430, a read only memory (ROM) 440, a storage device 450, an input device(s) 460, an output device(s) 470, and a communication interface(s) 480. Bus 410 may include a path that permits communication among the components of network device 400.

Processing unit 420 may include one or more processors or microprocessors, or processing logic, which may interpret and execute instructions. Main memory 430 may include a random access memory (RAM) or another type of dynamic storage device that may store information and instructions for execution by processing unit 420. ROM 440 may include a ROM device or another type of static storage device that may store static information and instructions for use by processing unit 420. Storage device 450 may include a magnetic and/or optical recording medium. Main memory 430, ROM 440 and storage device 450 may each be referred to herein as a “tangible non-transitory computer-readable medium.”

Input device 460 may include one or more mechanisms that permit an operator to input information to network device 400, such as, for example, a keypad or a keyboard, a display with a touch sensitive panel, voice recognition and/or biometric mechanisms, etc. Output device 470 may include one or more mechanisms that output information to the operator, including a display, a speaker, etc. Input device 460 and output device 470 may, in some implementations, be implemented as a user interface (UI) that displays UI information and which receives user input via the UI. Communication interface(s) 480 may include a transceiver that enables network device 400 to communicate with other devices and/or systems. For example, communication interface(s) 480 may include wired or wireless transceivers for communicating via content delivery network 325 or network 210.

The configuration of components of network device 400 illustrated in FIG. 4 is for illustrative purposes. Other configurations may be implemented. Therefore, network device 400 may include additional, fewer and/or different components than those depicted in FIG. 4.

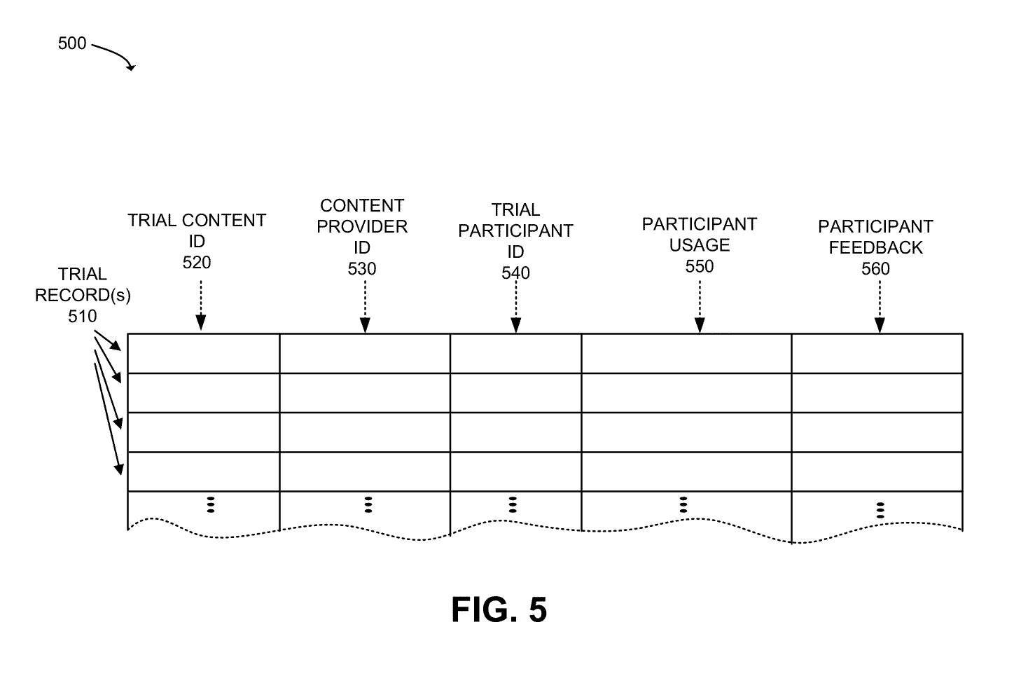

FIG. 5 depicts an exemplary data structure 500 that stores one or more trial records 510 that each correspond to an item of digital trial content provided by a respective content provider 110 for trial usage by customers. As shown, each trial record 510 may include a trial content identifier (ID) field 520, a content provider ID field 530, a trial participant ID field 540, a participant usage field 550 and a participant feedback field 560.

Trial content ID field 520 may store a unique identifier for digital content that the content provider, identified in field 530, provides to DCDP 100 for trial usage. Content provider ID field 530 may store a unique identifier associated with one of content provider(s) 110 that provided the trial digital content identified by trial content ID field 520. Trial participant ID field 540 may store data that uniquely identifies a customer who has volunteered to participate in trial usage of the digital trial content identified by trial content ID field 520.

Participant usage field 550 may store data that details the customer identified by field 540, and that customer's usage of the digital content, including digital trial content. Usage of the digital trial content may include any and all interactions of the customer with DCDP 100 that occurs either before, during or after usage of the digital trial content. Participant feedback field 560 may store data that includes any feedback, ratings, or comments supplied by the customer identified in field 540 related to digital content, promotions, or ads.

The number and content of the fields of each trial record 510 in FIG. 5 is for illustrative purposes. Each trial record 510 may include additional, fewer and/or different fields than those depicted in FIG. 5. Data structure 500 is depicted in FIG. 5 as a tabulated data structure for purposes of illustration. Other types of data structures, not shown, may also be used for associating data fields 520-560 within data structure 500.

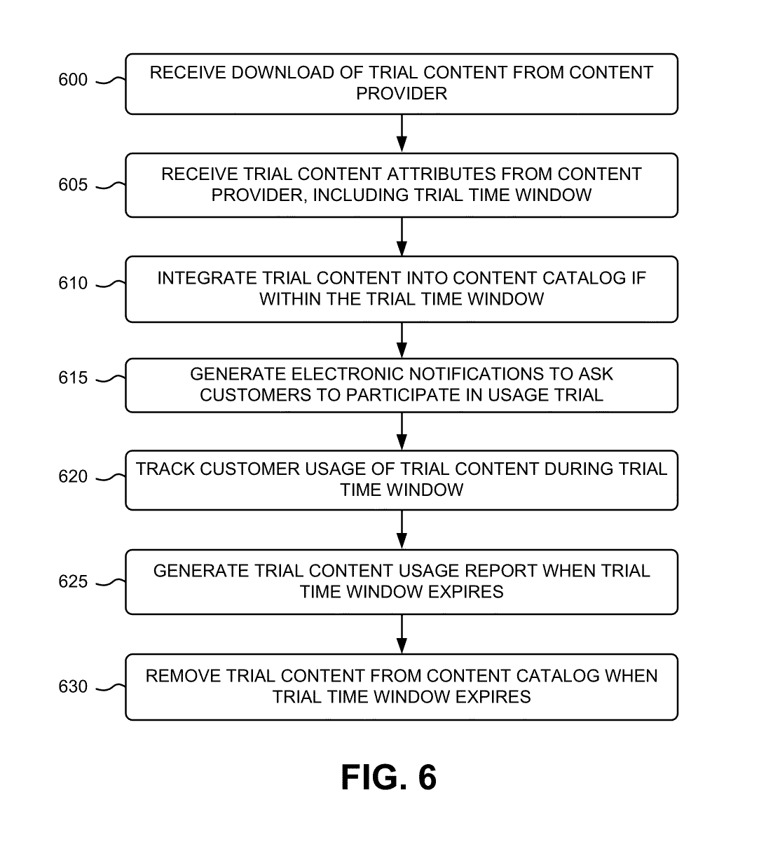

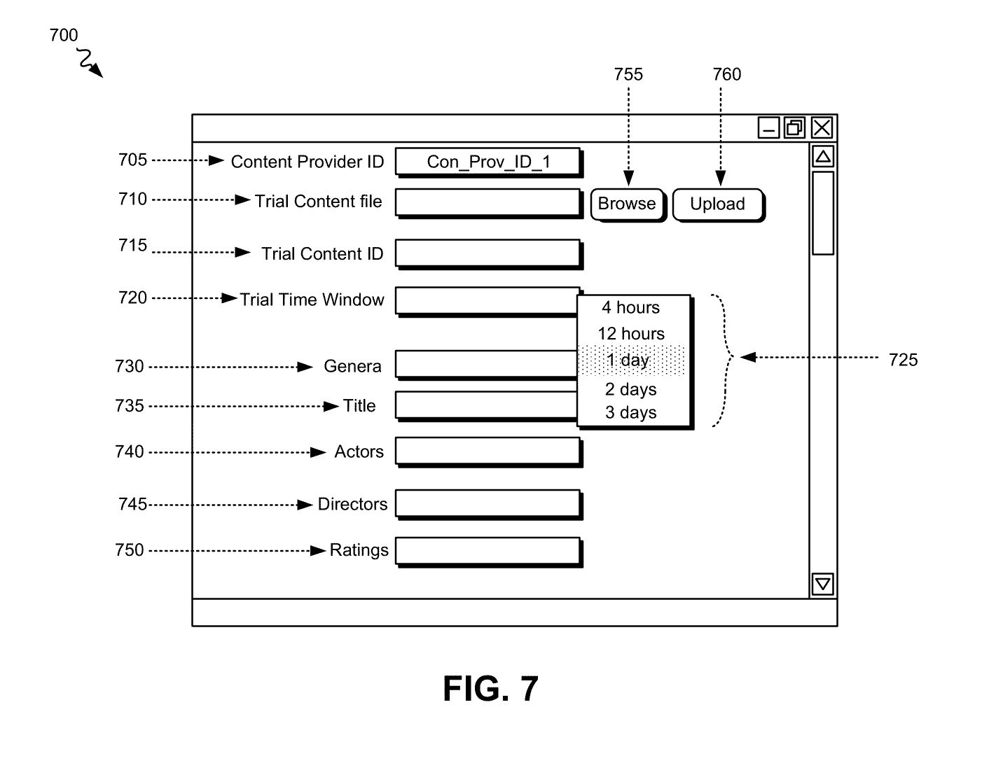

FIG. 6 is a flow diagram of an exemplary process for receiving digital trial content at DCDP 100 and conducting usage trials of the received trial content. The exemplary process of FIG. 6 is performed by DCDP 100. The description of the exemplary process of FIG. 6 below refers to the exemplary user interface diagram of FIG. 7. The exemplary process of FIG. 6 may be repeated for each item of digital trial content downloaded to DCDP 100 from a content provider 110 for placement in a usage trial.

The exemplary process may include DCDP 100 receiving a download of digital trial content from a content provider 110 (block 600) and receiving trial content attributes from content provider 110, including a trial time window (block 605). The trial content attributes may be provided separately, or at the same time as, the download of the digital trial content. An administrator of a content provider 110 may select digital trial content for upload to DCDP 100, and may upload the selected trial content via network 210 for download at DCDP 100. FIG. 7 depicts an exemplary user interface 700 that the administrator of content provider 110 may use to upload digital trial content. User interface 700 may include multiple different fields for entering various data regarding the digital trial content which the administrator of the content provider 110 desires to upload to DCDP 100. For example, user interface 700 may include a content provider ID field 705, a trial content file field 710, a trial content ID field 715, a trial time window field 720, a genera field 730, a title field 735, an actors field 740, a directors field 745, and a ratings field 750. Fields 720-750 may store the trial content attributes for the digital trial content.

Content provider ID field 705 may store a unique identifier for identifying the content provider 110 that is uploading the digital trial content. Trial content file field 710 may identify the file that includes the digital trial content. The administrator at content provider 110 may select browse button 755 to search memory storage to locate the stored trial content file. Trial content ID field 715 may store a globally unique identifier that may be used by DCDP 100 to distinguish the trial content from all other trial content files uploaded by this content provider 110, or by other content providers. In some implementations, a value for the trial content ID may be automatically provided in field 715 by DCDP 100. Trial time window 720 may store the provider-selected time period for conducting the usage trial of the trial content. For example, a drop-down menu 725 may be used to select a specific time period (e.g., 4 hours, 12 hours, 1 day, 2 days, 3 days). Additionally, though not shown in FIG. 7, trial time window 720 may permit the content provider 110 to specify exact dates (e.g., a date range) for conducting the usage trial.

Fields 730-750 may store descriptive information about the trial content identified by trial content ID field 715. For example, genera field 730 may store data that describes a type, or a group of content, that is associated with the trial content (e.g., science fiction, action, horror, comedy). Title field 735 may store a textual title associated with the trial content (e.g., the title of a given movie). Actors field 740 may store data that details the actors who perform within the trial content. Directors field 745 may store data that identifies the director(s) associated with the trial content (e.g., movie director). Ratings field 750 may identify a specific rating for the trial content that provides information related to which categories of audiences may be appropriate for the trial content. For example, ratings field 750 may store Motion Picture Association of America ratings for the trial content (e.g., G, PG-13, PG, R). Upon completion of entry of appropriate data related to the trial content into user interface 700, the administrator of content provider 110 may select upload button 760 to upload the trial content, and associated attributes, to DCDP 100.

Returning to FIG. 6, DCDP 100 may integrate the received trial content into the content catalog if a current time is within the trial time window (block 610). Subsequent to formatting, transcoding and encrypting by content processing server(s) of DCDP 100, the trial content may be inserted into the content catalog stored at content catalog server(s) 340-1 such that the trial content may be searched and/or browsed. DCDP 100 may generate electronic notifications to ask customers to participate in a usage trial of the received trial content (block 615). Upon insertion into the content catalog stored at content catalog server(s) 340-1, notification server(s) 345-3 of DCDP 100 may generate one or more electronic notifications to offer customers an opportunity to participate in a usage trial of the trial content. The one or more electronic notifications may include email notifications, Instant Message (IM) notifications, social network notifications, or other types of electronic notifications.

DCDP 100 may track customer usage of the digital trial content during the trial time window (block 620). Usage tracking server(s) 340-4 of DCDP 100 may track interaction of the customer with the digital trial content, or with DCDP 100 before, during, or after usage of the trial content. The tracked usage may include the following:

1) time spent browsing the trial content by each customer;

2) time spent previewing the trial content by each customer;

3) time spent consuming (e.g., watching/listening/using) the trial content by each customer;

4) details of how the trial content was consumed (watched/listened/used) by each customer (e.g., pause positions, fast forward positions, stop positions, repeated positions).

5) each customer's feedback for the trial content;

6) each customer's feedback for promotions/advertisements presented to the customer in conjunction with the trial content;

7) a type of customer device (e.g., computer, mobile phone, TV) used to engage in the trial usage; and/or

8) a location of the customer's trial usage (e.g., city, geographic location by latitude/longitude).

Usage tracking server(s) 340-4 may store data related to tracking the usage of the trial content by each customer for future analysis and for generating a usage report when the trial time window expires. For example, for each customer identified in trial participant ID field 540 of data structure 500, the customer's tracked usage may be stored in participant usage field 550, and the customer's feedback may be stored in participant feedback field 560.

DCDP 100 may generate a trial content usage report when the trial time window expires (block 620). Upon determining that the trial time window has expired for the digital trial content, usage tracking server(s) 340-4 may generate a report that includes, for example, the following information:

1) a title of digital trial content being browsed and by how many customers;

2) a title of digital trial content being previewed and by how many customers;

3) a title of digital trial content being watched/listened to and by how many customers;

4) a title of digital trial content and how the trial content was watched/listened to by customers (e.g., pause positions, fast forward positions, stop positions, repeating positions).

5) what other titles of digital trial content that a customer watched who watched a given title of digital trial content;

6) customers' feedback for each title; and/or

7) customers' feedback for promotions/advertisements associated with given titles of digital trial content.

DCDP 100 may remove the digital trial content from the content catalog when the trial time window expires (block 630). Upon expiration of the trial time window for a given item of digital trial content, content catalog server(s) 340-1 may delete the trial content from the content catalog so that it is no longer accessible to customers.

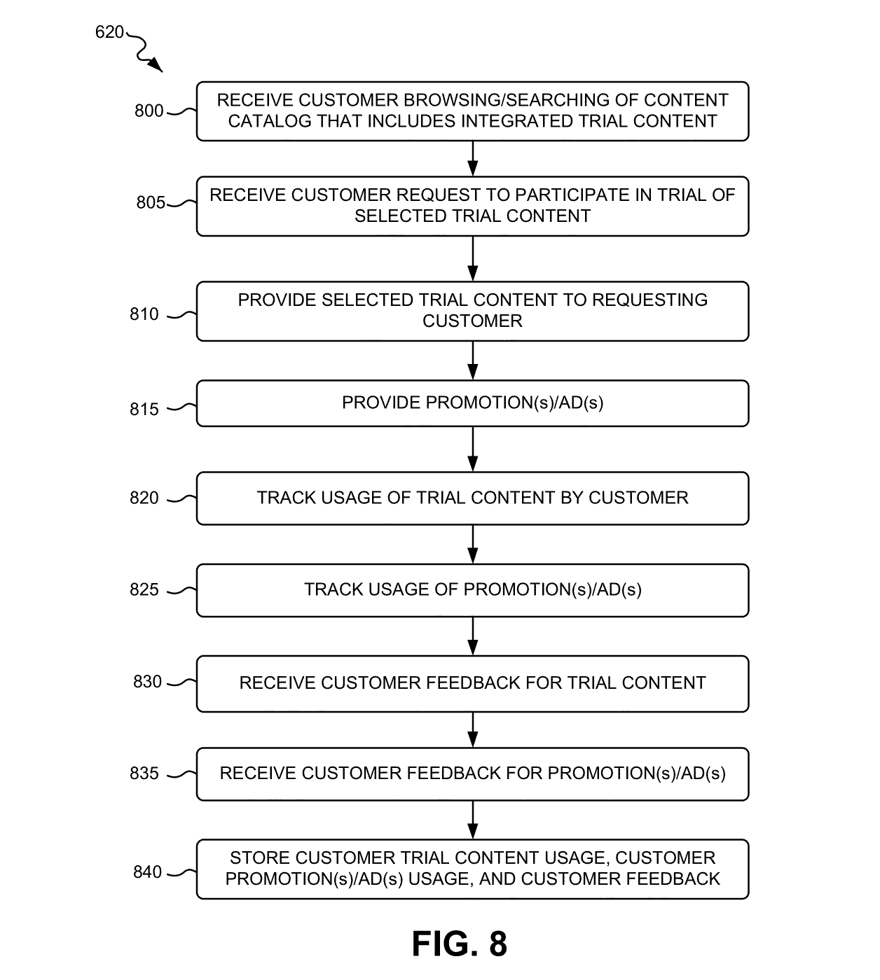

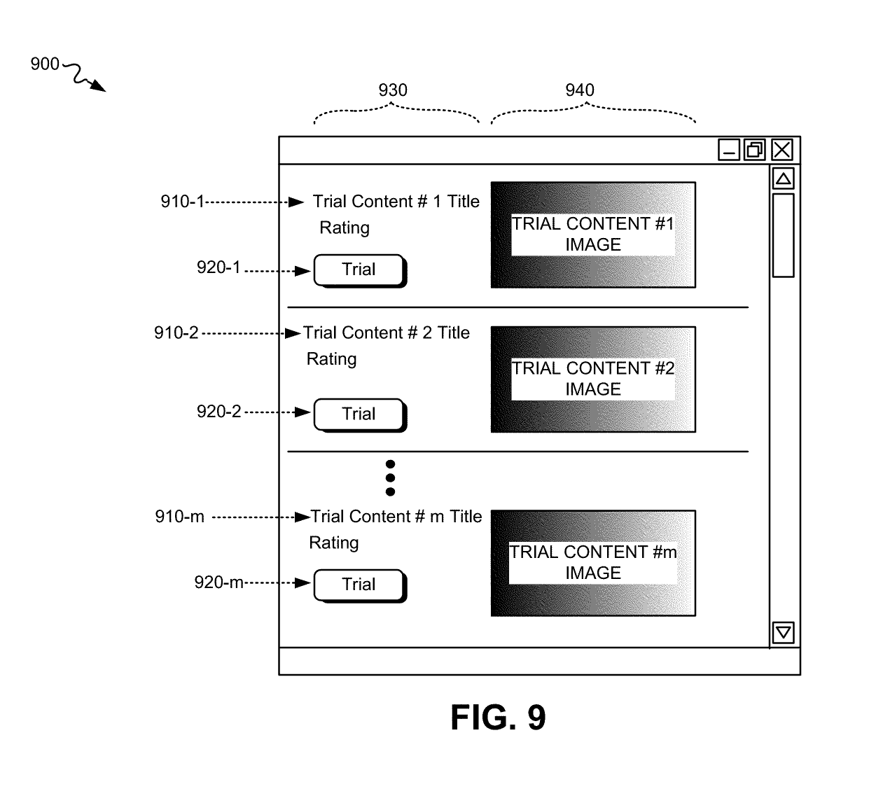

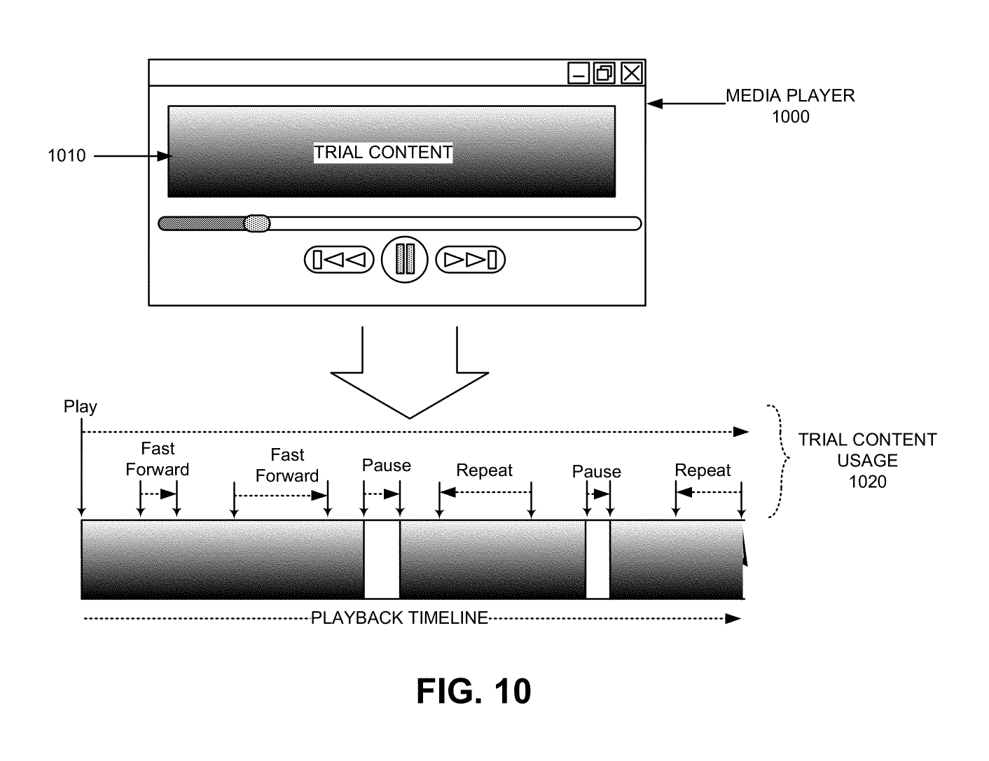

FIG. 8 is a flow diagram that depicts further exemplary details of the trial content customer usage tracking of block 620 of FIG. 6. The description of the exemplary process of FIG. 8 below refers to the exemplary diagrams of FIGS. 9 and 10.

The exemplary process may include DCDP 100 receiving customer browsing and/or searching of the content catalog that includes the integrated trial content (block 800). For example, while browsing/searching the content catalog, a user interface 900 at customer device 125 may present one or more items of digital trial content 910-1 through 910-m (where m is greater than or equal to one) obtained from DCDP 100. The one or more items of digital trial content 910-1 through 910-m presented in user interface 900 may include trial content information 930 that describes the trial content (e.g., title, rating, etc.), and an image 940 that graphically or pictorially identifies the trial content. If the trial content comprises video content, then image 940 may include a still image from the video content. If the trial content includes gaming content, then image 940 may include an image that is descriptive of the content of the game.

DCDP 100 may receive a customer request to participate in a usage trial of selected trial content (block 805). Referring to the exemplary user interface 900 of FIG. 9, a customer at the customer device 125 may select one of the “trial” buttons 920-1 through 920-m associated with a respective item of trial content with which the customer wishes to engage in a usage trial. Customer device 125 may provide an identification of the selected item of digital trial content to DCDP 100 for retrieval and delivery. DCDP 100 may provide the selected trial content to the requesting customer (block 810).

DCDP 100 may additionally provide a promotion(s) and/or an ad(s) to the customer (block 815). Offer management server(s) 345-4 of DCDP 100 may generate a promotion(s) and/or ad(s) that may be of interest of the customer and may present the promotion(s) and/or ad(s) in conjunction with the trial content. The promotion(s) may include a special offer related to, for example, other content stored in content catalog 120. The ad(s) may include a textual, graphical, audio and/or video advertisement of other content stored in content catalog 120, or of a product or service that may be of interest to the customer.

DCDP 100 may track usage of the trial content by the requesting customer (block 820). FIG. 10 depicts an exemplary media player 1000 that may be implemented at customer device 125 to present trial content 1010 to the customer. During playback of the trial content, usage 1020 of the trial content may be tracked by DCDP 100. For example, as shown along the playback timeline of FIG. 10, media player 1000 may report a duration of the playback, positions along the playback timeline at which fast forwarding occurs, positions along the playback timeline at which playback is paused, and positions along the playback timeline at which playback is repeated. DCDP 100 may also track the customer's usage of the promotion(s) and/or ad(s) (block 825). DCDP 100 may track any action of the customer with the promotion(s) and/or ad(s), such as viewing, browsing, accepting an offer, etc. DCDP 100 may store data related to the promotion(s)/ad(s) usage in participant usage field 550 of data structure 500.

DCDP 100 may receive customer feedback for the trial content (block 830). The customer at the customer device 125 may provide feedback related to the digital trial content. Such feedback may include rating the content (e.g., on a scale from 1 to 10), or providing textual comments. DCDP 100 may also receive customer feedback for the promotion(s) and/or ad(s) (block 835). The customer at the customer device 125 may provide feedback related to the promotion(s) and/or ad(s) provided in conjunction with the trial content. The feedback may include a rating indicating the interest of the promotion(s)/ad(s) to the customer, or textual comments directed to the content of the promotion(s)/ad(s).

DCDP 100 may store customer trial content usage, customer promotion(s)/ad(s) usage, and customer feedback in a trial record 510 of data structure 500 (block 840). DCDP 100 may store data related to the trial usage of the trial content in participant usage field 550, data related to the promotion(s)/ad(s) usage in participant usage field 550, data related to the customer's feedback related to the trial content and/or the customer's feedback related to the promotion(s)/ad(s) in participant feedback field 560 of data structure 500.

As described herein, a digital content distribution platform conducts usage trials of digital content provided by content providers based on trial time windows specified by those content providers. During the trial time window of a given usage trial, customers may be electronically notified of the ability to participate in the content trials. When a customer elects to participate in a usage trial of a certain item of digital trial content, the digital content distribution platform tracks the customer's interactions with the content and/or with the digital content distribution platform. At the expiration of a trial time window for a given usage trial, the digital content distribution platform generates a usage report that details the customer's usage of the trial content.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 6 and 8, the order of the blocks may be varied in other implementations. Moreover, non-dependent blocks may be performed in parallel. In addition to electronic notifications of usage trials of digital trial content being sent by DCDP 100, customers may use social networks to invite other customers (e.g., friends and family) to a usage trial. For example, one customer can use a social network (e.g., Facebook, Groupon) to collect trial users, and the price the group pays for the usage trial is based on the number of users (e.g., 100 users pay $5 each, 1000 users pay $3 each).

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, at a first network device associated with a digital content distribution platform, a download of first digital trial content from a first digital content provider;
receiving, at the first network device, first attributes associated with the first digital trial content, including a first trial time window;
receiving, at the first network device, a download of second digital trial content from a second digital content provider that is different than the first digital content provider;
receiving, at the first network device, second attributes associated with the second digital trial content, including a second trial time window;
offering, via electronic notification, trial usage of the first trial content during the first trial time window;
receiving requests from a plurality of first customers to participate in the trial usage of the first trial content; and
tracking, based on the requests and during the first trial time window, usage of the first trial content by the plurality of first customers to generate a first usage report.

2. The method of claim 1, further comprising:
storing, at a second network device associated with the content distribution platform, the first and second digital trial content in a content catalog; and
permitting the plurality of first customers to browse the content catalog.

3. The method of claim 1, wherein the first and second digital trial content comprise digital video content.

4. The method of claim 3, wherein the digital video content comprises at least a portion of a movie or a series of movies.

5. The method of claim 1, further comprising:
offering, via electronic notification, trial usage of the second digital trial content during the second trial time window;
receiving requests from a plurality of second customers to participate in trial usage of the second digital trial content; and
tracking, during the second time trial window, usage of the second digital trial content by the plurality of second customers to generate a first second report.

6. The method of claim 5, further comprising:
electronically sending the second usage report to the second digital content provider.

7. The method of claim 1, further comprising:
electronically sending the first usage report to the first digital content provider.

8. A digital content distribution platform, comprising:
one or more network devices configured to:
receive downloads of first digital trial content from a first digital content provider and second digital trial content from a second digital content provider,
receive a first trial time window associated with the first digital trial content and a second trial time window associated with the second digital trial content,
offer, via electronic notification, trial usage of the first trial content during the first trial time window,
receive requests from a plurality of first customers to participate in the trial usage of the first trial content, and
track, based on the requests and during the first trial time window, usage of the first trial content by the plurality of first customers to generate a first usage report.

9. The digital content distribution platform of claim 8, wherein the one or more network devices are further configured to:
store the first and second digital trial content in a content catalog, and
permit the plurality of first customers to browse the content catalog.

10. The digital content distribution platform of claim 8, wherein the first and second digital trial content comprise digital video content.

11. The digital content distribution platform of claim 10, wherein the digital video content comprises at least a portion of a movie or a series of movies.

12. The digital content distribution platform of claim 8, wherein the one or more network devices are further configured to:
offer, via electronic notification, trial usage of the second digital trial content during the second trial time window,
receive requests from a plurality of second customers to participate in trial usage of the second digital trial content, and
track, during the second time trial window, usage of the second digital trial content by the plurality of second customers to generate a first second report.

13. The digital content distribution platform of claim 12, wherein the one or more network devices are further configured to:
send the first usage report to the first digital content provider, and
send the second usage report to the second digital content provider.

14. A method, comprising:
receiving, at a content distribution platform, a respective trial time window for each of a plurality of items of digital content stored at the content distribution platform;
offering, from the content distribution platform, one of the items of the digital content to a plurality of customers during the respective trial time window;
tracking, at the content distribution platform and during the respective trial time window, usage of the one of the plurality of items of digital content by one or more of the plurality of customers; and
generating, based on the tracked usage, a first usage report for the one of the plurality of items of digital content at expiration of the respective trial time window.

15. The method of claim 14, further comprising:
receiving, at the content distribution platform, downloads of the plurality of items of digital content.

16. The method of claim 14, wherein the respective time trial time window for each of the plurality of items of digital content defines a time period during which each of the plurality of items of digital content is offered for a trial usage.

17. The method of claim 14, wherein tracking the usage of the one of the plurality of items of digital content comprises tracking one or more of the following:
a) time spent browsing the one of the plurality of items of digital content by each of the one or more of the plurality of customers;
b) time spent previewing the one of the plurality of items of digital content by each of the one or more of the plurality of customers;
c) time spent watching or listening to the one of the plurality of items of digital content by each of the one or more of the plurality of customers;
d) details of how the one of the plurality of items of digital content was watched or listened by each of the one or more of the plurality of customers;
e) each of the one or more of the plurality of customers' feedback for the one of the plurality of items of digital content; or
f) each of the one or more of the plurality of customers' feedback for promotions/advertisements presented to the customer in conjunction with the one of the plurality of items of digital content.

18. The method of claim 14, wherein the one of the plurality of items of digital content comprises an item of digital video content.

19. The method of claim 18, wherein the item of digital video content comprises at least a portion of a movie or a series of movies.

20. The method of claim 14, wherein the generated first usage report includes one or more of the following:
a) how many of the one or more of the plurality of customers browsed the one of the plurality of items of digital content;
b) how many of the one or more of the plurality of customers previewed the one of the plurality of items of digital content;
c) how many of the one or more of the plurality of customers watched or listened to the one of the plurality of items of digital content;
d) how the one of the plurality of items of digital content was watched or listened to by the one or more of the plurality of customers;
e) the one or more of the plurality of customers' feedback for the one of the plurality of items of digital content;
f) the one or more of the plurality of customers' feedback for promotions or advertisements associated with the one of the plurality of items of digital content; or
g) what other of the plurality of items of digital content the one or more of the plurality of customers watched or listened to that watched or listened to the one of the plurality of items of digital content.
